(19) United States
(12) Patent Application Publication
(10) Pub. No.: US 2003/0009853 A1
(43) Pub. Date: Jan. 16, 2003

(54) Locking device with improved jumping means for retractable handle of luggage

(75) Inventor: Chung Hsien Kuo, Pan-Chiao City (TW)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Chaw Khong Technology Co., Ltd.

(21) Appl. No.: 09/904,483

(22) Filed: Jul. 13, 2001

(51) Int. Cl. E05B 1/00

(52) U.S. Cl. 16/405

(57) ABSTRACT

A handle assembly of luggage comprises a handle grip with a push button, two first sliding tubes, at least one pair of second sliding tubes, two supporting tubes, two first locking devices, each provided below each first sliding tube, at least one pair of jumping means, at least one pair of second locking devices, each having a spring receptacle provided below each second sliding tube, a pair of first connecting means attached between the handle grip and the first locking devices, and at least one pair of second connecting means for controlling the second locking devices. The first sliding tubes, the second sliding tubes, and the supporting tubes are activated at positions irrelevant to their respective lengths due to the provision of the second locking device at the bottom of the second sliding tube. As a result, with any combination of lengths of the luggage handle's supporting barrels, the retracted first sliding tube may abruptly but smoothly jump out of the second sliding tube whenever the jumping means is activated. This enables a quick assembly of the luggage handle system, which in turn accommodates the manufacturing of quality luggage.

### CROSS-REFERENCE TO RELATED APPLICATION

Reference is made to pending application (Attorney Docket No. 890-003.016), entitled LOCKING DEVICE FOR RETRACTABLE HANDLE OF LUGGAGE, assigned to the assignee of this application and filed on even date herewith.

### BACKGROUND OF THE INVENTION

1. Field of the Invention

The present invention relates to a retractable handle of luggage and more particularly to a locking device with improved jumping means for a multi-stage retractable handle of a luggage.

2. Description of Related Art

Conventionally, the handle grip of a retractable handle assembly is usually withdrawn into a bezel located on top of the luggage. For such a design, the provision of the bezel generally prevents the luggage handle from being hit and damaged by outside objects, which may eventually cause damage to the luggage handle when it is not in use. When the handle grip is in use, however, the user simply presses the push button on the luggage handle and unlocks the locking device to raise the handle grip. However, the recessed position of the handle grip often tends to be too close to the bezel to help the user get hold of the luggage handle. For this reason, a jumping means is always provided in the bottom of the handle system to accommodate the handle's easy lifting and also enables it to jump up a small distance whenever the push button is pressed. With this jumping means of the two-stage luggage handle system, the user can very easily grasp the luggage handle and stretch the handle grip to any desired length. Nevertheless, for the multi-stage luggage handle system, if the jumping means is also provided in the bottom of the supporting tube, since there is a length difference between the first sliding tube and the second sliding tube or a length difference between the second sliding tube and the supporting tube, it is difficult to adjust the anchoring position of the spring receptacle so that the first sliding tube cannot be easily attained at a desirable position relative to the spring receptacle in order to obtain an optimum jumping effect.

Moreover, the above mentioned indispensable consideration for the process of adjusting the spring receptacle's anchoring position complicates the assembling process in manufacturing, which in turn devaluates the quality of the luggage.

In view of this, the opinion that the previous design will inexorably produce a complexity to the manufacturing of luggage itself is something that is beyond dispute.

### SUMMARY OF THE INVENTION

It is therefore an objective of the present invention to provide a locking device with improved jumping means for a multi-stage retractable handle of luggage. With the provision of the jumping means located at the bottom of the first locking devices and the spring receptacles located in the second locking devices, a desirable position of the jumping means relative to the spring receptacles is obtained. Such a design assures better jumping, smooth retraction, and a quick extension of the locking device for the multistage retractable luggage handle.

Another objective of the present invention is to provide a locking device with an improved jumping means for the multi-stage retractable handle of luggage, wherein each of the first sliding tubes, the second sliding tubes, and the supporting tubes are activated in a position which is irrelevant to the respective length of the first sliding tubes, the second sliding tubes, and the supporting tubes. Due to the provision of the second locking device at the bottom of the second sliding tube, the retracted first sliding tube may jump out of the second sliding tube whenever the jumping means is activated. Such a deployment can enable the manufacturer to manufacture a first sliding tube and a second sliding tube with suitable respective lengths based entirely on the customers' preferences derived from their personal ideas about comfort and convenience. As a result, it is possible to produce a great variety of luggage handles with different retraction lengths.

It is a further object of the present invention to provide a locking device with improved jumping means for a multi-stage retractable handle of luggage, wherein the length of fully extended handle is longer than the height of the luggage for providing a handle with extended sufficient length to the user when towing a small luggage piece along the ground.

It is still further object of the present invention to provide a locking device with improved jumping means for a multi-stage retractable handle of luggage, wherein the handle grip can be pulled a sufficient distance above the recess on top of luggage and locked therein so as to provide a convenient carry-on handle to the user when lifting luggage.

To achieve the above mentioned and other objectives, the present invention provides a handle system of luggage with two identically symmetric parts. For this new handle system, each part comprises a handle grip and a push button provided thereon, a first sliding tube affixed to the end of the handle grip, a first locking device detachably attached to the bottom of the first sliding tube, a jumping means provided at the bottom of the first locking device, a second sliding tube for allowing the first sliding tube to glide freely therein and with a plurality of holes drilled upon it, a second locking device detachably attached to the bottom of the second sliding tube, a supporting tube for allowing the second sliding tube to glide freely therein and with a plurality of holes drilled upon it, a first connecting means connected between the push button and the first locking device, and a second connecting means clung between the first locking device and the second locking device; wherein the second locking device consists of a second housing having a longitudinally disposed spring receptacle, a sliding block longitudinally slidable within the second housing, a helical spring laterally biased within the lower part of the second housing, a locking block laterally slidable, and a second connecting means having the top end clung to the first locking device and the bottom end clung to the longitudinally disposed sliding block.

The above mentioned and other objectives, features, and advantages of the present invention will become apparent from the following detailed description made in conjunction with the accompanying FIGS. 1-8.

### BRIEF DESCRIPTION OF THE DRAWINGS

FIG. 1 is an exploded view of a preferred embodiment of a retractable handle on the right-hand side of a luggage piece according to the invention;

FIG. 2 is an exploded view of the jumping means of FIG. 1;

FIG. 3 is a cross-sectional view of the assembled locking device;

FIG. 4 is similar to FIG. 3, where the push button is pressed to allow the first connecting means to pull back the first locking block and to cause it to retract from its allocation hole so that the first sliding tube, along with the handle, is unlocked;

FIG. 5 is similar to FIG. 4, where after the first locking block is unlocked, the jumping means is activated to cause the first locking device to jump up, which in turn lifts the first sliding tube;

FIG. 6 is similar to FIG. 5, where the first sliding tube is lifted to pull up the second connecting means so as to cause the longitudinally disposed sliding block on the second locking device to retract the generally cubic-shaped laterally disposed locking block which in turn leads to the unlocking of the second locking device;

FIG. 7 is similar to FIG. 6, where after the generally cubic-shaped locking block is unlocked, the second locking device is activated by the second connecting means to cause the second locking device to move upward, which in turn leads to the protraction of the second sliding tube; and

FIG. 8 is an exploded view of a preferred embodiment of a retractable handle on the left-hand side of the luggage according to the invention.

### DETAILED DESCRIPTION OF THE PREFERRED EMBODIMENTS

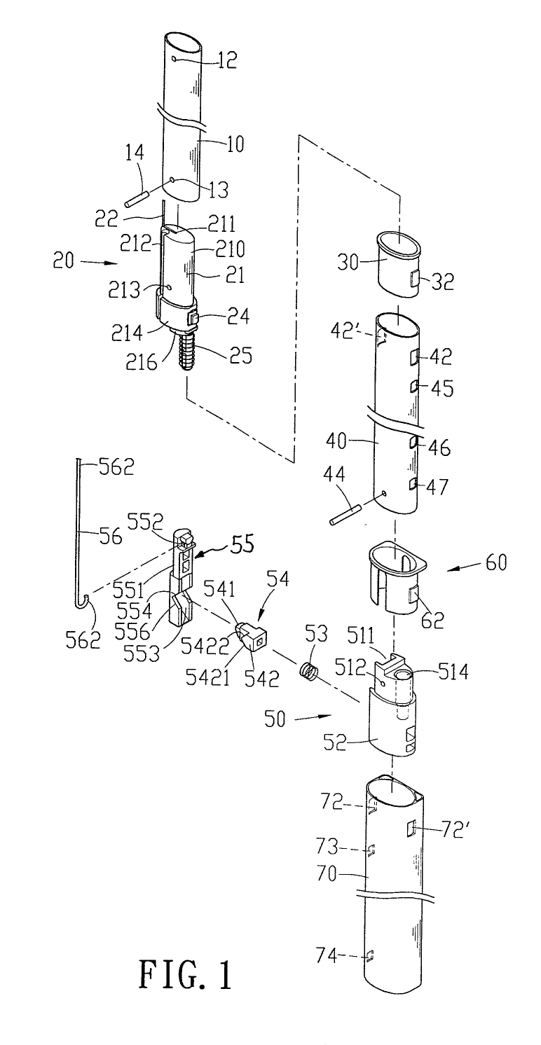

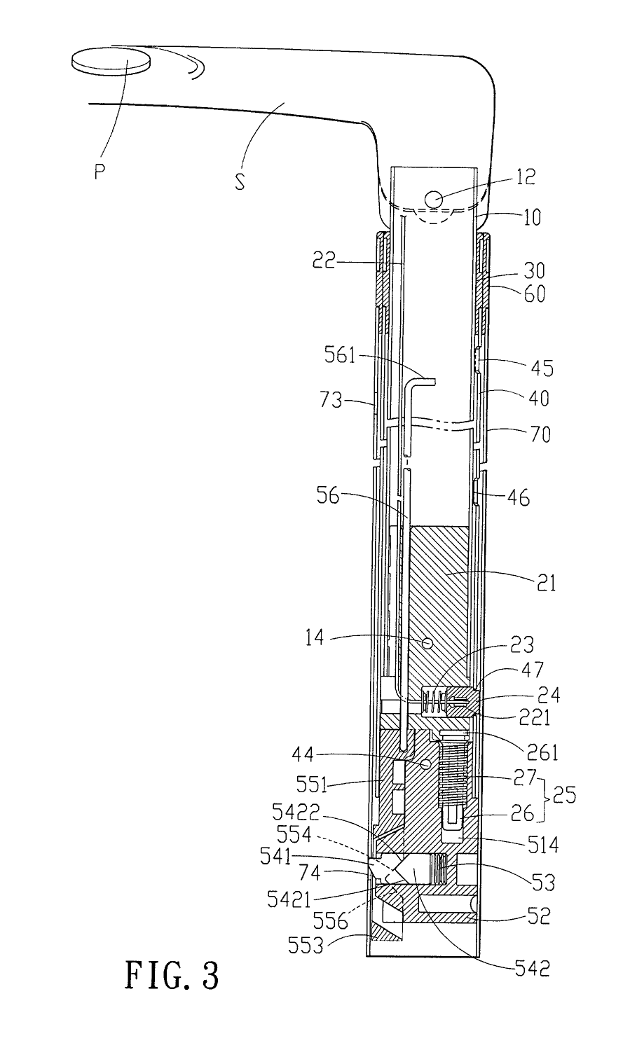

FIGS. 1 to 3 show a locking device with an improved jumping means for the retractable handle of a luggage constructed in accordance with the present invention, wherein the handle system is provided at the back of a luggage piece with a handle grip S having a push button P installed upon it; the handle system is recessed into a receiving bezel on the top of the luggage when it is not in use.

Note that since the present handle assembly is bilaterally symmetric, the description on one side of the handle system serves to speak for both the entities. The stretching mechanism of the present handle system comprises a first sliding tube 10, a first locking device 20 with an appendixed jumping means 25, a first sleeve member 30, a second sliding tube 40, a second locking device 50, a second sleeve member 60, and a supporting tube 70. While all the major composing members of the present invention generally could have a variety of cross section options (for example, the oval or elliptic shape, the square shape, the rectangular shape, and the polygonal shape), the forthcoming narrative is based on a general outer surface profile of an oval or elliptic shape. The first sliding tube 10 takes the form of a metal tube of a laminar elliptic cross section with a lower hole 13 and an upper hole 12 drilled upon it. The upper hole 12 is connected to the receiving opening on one side of the handle grip S through a known fastener.

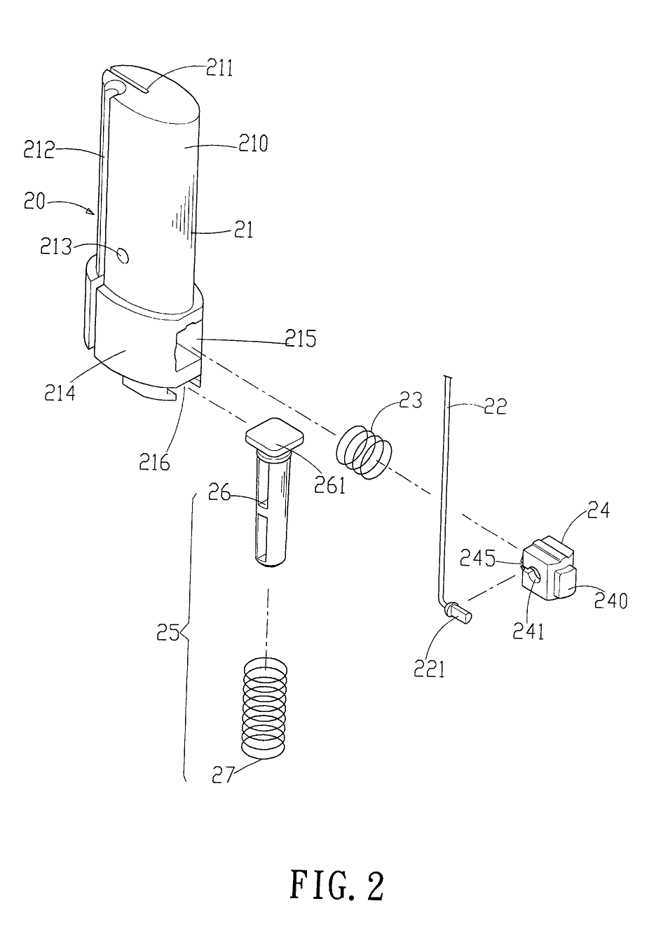

The first locking device 20 comprises a first housing 21, a first connecting means 22, a helical spring 23, a first locking block 24, and a jumping means 25. The first housing 21 is composed of a retaining groove 211 at the top of the elongation 210, a longitudinal guide groove 212, a laterally traversed pin hole 213, a lateral tunnel opening 215 (See FIG. 2) provided at the lower bottom portion 214, and a lateral guide groove 216 located below the lower bottom 214. The laterally traversed pin hole 213 is provided to allow a pin 14 to be inserted into the hole 213 on the first housing 21 and the hole 13 at the lower part of the first sliding tube 10 to secure the first housing 21 to the first sliding tube 10. The first connecting means 22 has a top hook end (not shown) secured to the handle grip S and a bottom hook end 221 secured into the hollow opening 245 on the first locking block 24 through a path which starts from the retaining groove 211 at the top of the elongation 210 of the first housing 21, the lateral opening 215, and reaches the hollow opening 241 of the first locking block 24 such that the mere pressing of the push button P may actuate the first connecting means 22 and the first locking device 20. The helical spring 23 is laterally provided inside the opening 215 at the bottom of the first housing 21 to bias against the first locking block 24 for the operation of locking or unlocking it. The first locking block 24 is provided to be inserted into the lateral opening 215 at the bottom of the first housing 21 and contains a projection 240 on a first side, an aperture 241 on a second side, and an opening 245 which is in communication with the aperture 241. The jumping means 25 consists of a limiting pin 26 and a helical spring 27. The limiting pin 26 includes a thin square shaped engagement member 261 on top and a longitudinally elongated cylindrical drape beneath it. The engagement member 261 is provided as a means to cling the limiting pin 26 onto the guide groove 216 beneath the bottom 214 of the first housing 21, while the cylindrical drape below it serves as an allocation member for the helical spring 27. The helical spring 27 is affixed around the limiting pin 26 and works as the action initiator of the luggage handle's jumping means 25.

The first sleeve member 30 has two slightly protruded projections 32 and 32′ located at the two opposite sides of the sleeve member's 30 outer surface. The second sliding tube 40 is provided to allow the first sliding tube 10 to glide freely therein and contains the top, center, and lower holes 45, 46, and 47 on a first side, two apertures 42 and 42′ on the first and third sides, and two pin holes 43 laterally drilled across the traversed other two sides. The two apertures 42 and 42′ on the first and third sides are provided to couple with the aperture projections 32 and 32′ of the first sleeve member 30. The two pin holes 43 are provided to allow the second locking device 50 to be detachably attached to the bottom of the second sliding tube 40 by using a pin 44 to secure the two bottom holes 43 and the laterally traversed tunnel holes 512 on the second locking device 50 together.

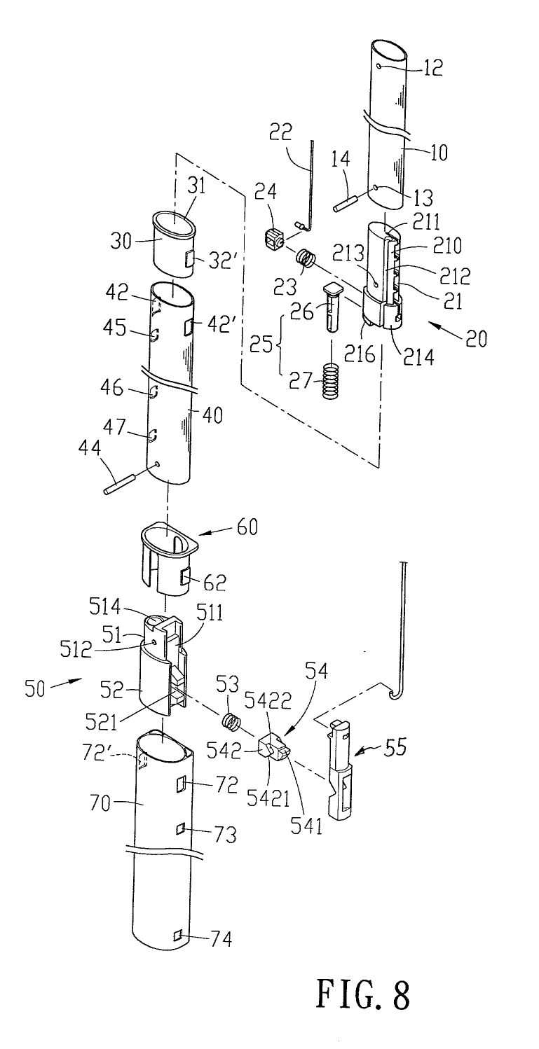

The second locking device 50 is formed by a second housing which includes an upper portion 51 and a lower portion 52 (see FIGS. 1 and 8). The upper portion 51 contains a longitudinal groove 511, two laterally traversed pin holes 512, and a longitudinally disposed spring receptacle 514 such that the pin 44 may be inserted through the lower holes 43 of the second sliding tube 40 and the pin holes 512 to secure the second locking device 50 and the second sliding tube 40 together. The lower portion 52 consists of a laterally allocated central dent 521, a helical spring 53, a cubic locking block 54, and a longitudinally deployed sliding block 55. The helical spring 53 is horizontally placed into the laterally disposed central dent 521 at the lower portion 52 of the second housing 50 and has one end biased against the inner wall of the lower portion 52. A generally cubic shaped locking block 54 goes against the helical spring's 53 other end and is slidable within the central dent 521 at the lower portion 52 of the second locking device 50. With one end biased against the helical spring 53, the locking block 54 contains a frontal lock pin 541 and two triangular projections 542 symmetrically provided at the two other sides of the locking block's 54 outer surface. The lock pin 541 fits into the lower portion 553 of the sliding block 55 to facilitate the coupling operation between the two triangular projections 542 and two V-shaped recesses 555 (See FIG. 8); each of the two triangular projections 542 has a lower slope 5421 and an upper slope 5422.

The sliding block 55 is longitudinally glidable along the groove 511 of the upper portion 51 of the second locking device 50 and on gliding, the sliding block 55 glides itself across the mouth of the horizontally disposed central dent 521 of the lower portion 52 of the second locking device 50. The sliding block 55 has an upper portion 551 and a lower portion 553. The upper portion 551 has an reversed-arch shaped groove 552 on top and a longitudinal sliding surface below it. The second connecting means 56 has a top L-shaped hook end 561 clung to the retaining groove 211 of the first housing 21 of the first locking device 20 and a bottom U-shaped hook end 562 clung to the arch-shaped groove 552 of the upper portion 551 of the sliding block 55.

The lower portion 553 has a side profile wider than the upper portion 551 and contains a longitudinally deployed rectangular recess 557 and two V-shaped recesses 555. The rectangular recess 557 is provided to communicate with the upper portion 551, and the two V-shaped recesses 555 are located on the two opposite sides of the sliding block's 55 outer surface; each of the two V-shaped recesses 555 has an upper slope 554 and a lower slope 556.

The second sleeve member 60 has two slightly protruded projections 62 and 62′ provided on the two opposite sides of the second sleeve member's 60 outer surface. A supporting tube 70 is provided for allowing the second sliding tube 40 to glide freely therein. The supporting tube 70 has a top and bottom hole 73 and 74 on a first side and two apertures 72 and 72′ on the first and third sides of the tube's outer surface; wherein the two apertures 72 and 72′ are provided for coupling with the projections 62 and 62′ of the second sleeve member 60.

The following narrative is a description of the operation procedure for the handle system of the present invention. Initially, the luggage handle's locking device is assumed to be at its retracted position.

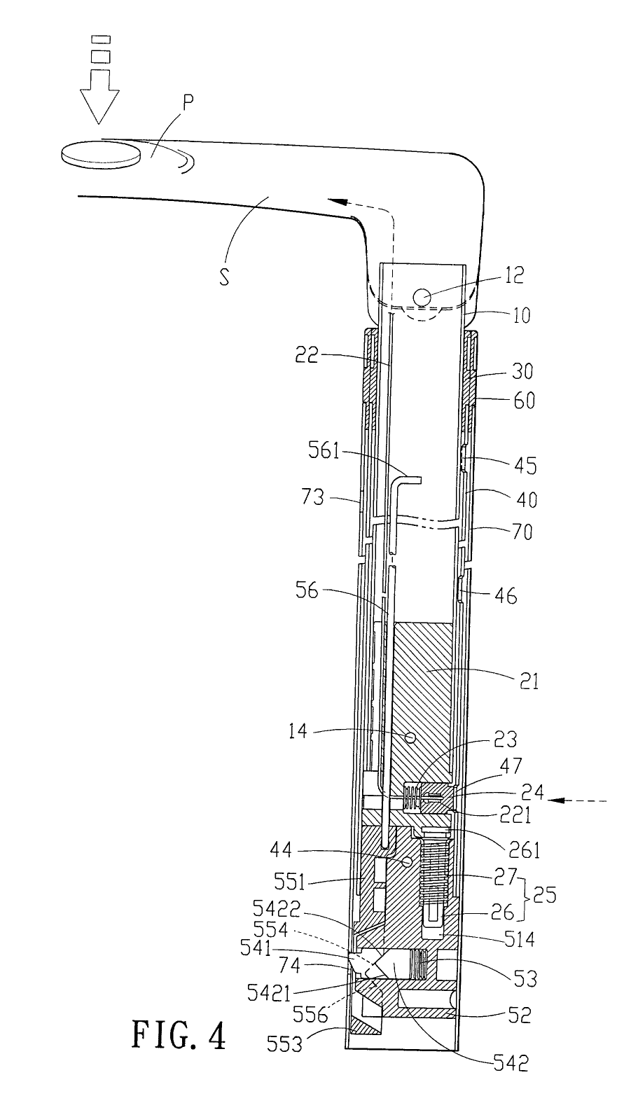

Referring to FIG. 4, when the push button P on the handle grip S is pressed by the user, the locking device is activated; the first connecting means 22 (in the form of a bendable metal cable) is tensely pulled up to induce the first locking block 24 to be dragged into the laterally disposed opening 215 (FIG. 2) so that the first locking block 24 is cleared of the lower hole 47 of the second sliding tube 40, and the first locking device 20 is thus unlocked.

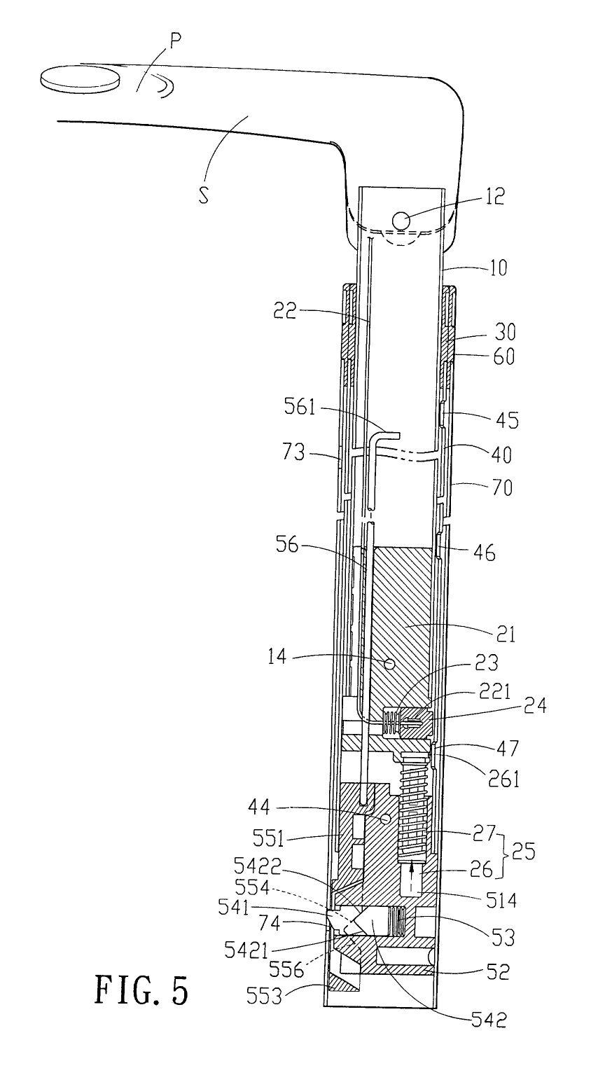

Referring to FIG. 5, after the user has pressed the push button P on the luggage handle S, the user immediately loosens hold of the handle grip S and releases the push button P. When the user releases the push button P, with the first locking block 24 and the allocation hole 47 still disengaged, the jumping means 25 is abruptly activated from below and instantly pushes up the first locking device 20 through the expansion of the upright helical spring 27. This chain reaction triggered by the user's mere pressing of the push button P results in the first locking device's 20 sudden elevation, which in turn leads to a prompt release of the first sliding tube 10. The resulting effect isthat the originally retracted handle grip S will jump up a small distance from its receiving bezel to help the user grasp the handle grip more easily.

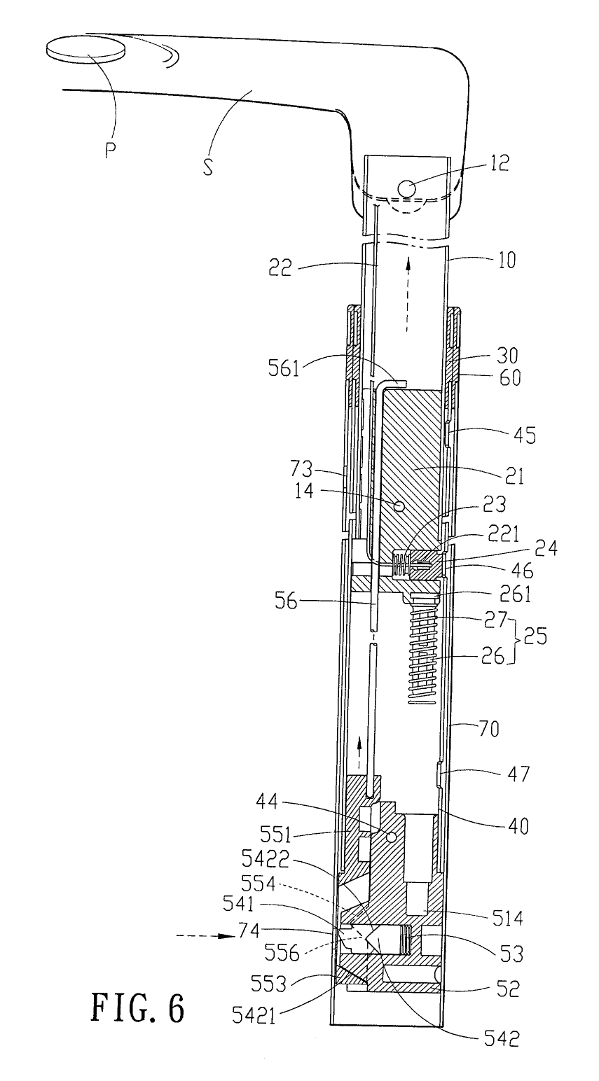

Referring to FIG. 6, the lifting action of the first sliding tube 10 allows the device's second connecting means' 56 upper L-shaped hook end 561 to cling to the retaining groove 211 at the top of the first housing 21 of the first locking device 20. At this point, if the first sliding tube 10 is further stretched by the user, since the second connecting means 56, in the form of a slim rigid metal section, is not a flexible element and has two deformed ends, the lifting of the second connecting means' 56 top hook end 561 spontaneously drags the bottom U-shaped hook end 562 upward. The U-shaped hook end 562 is clung to the reversed-arch shaped groove block 552 of the upper portion 551 of the sliding block 55, and the lifting of the second connecting means 56 also signals the raising of the sliding block 55. Followed by the elevation of the sliding block 55, the related ascent of the lower slope 556 of the sliding block 55 pushes the lower slope 5421 of the triangular projection 542 of the locking block 54 to displace laterally; this lateral displacement of the locking block 54 results in the disengagement of the locking block 54 from the lower hole 74 of the supporting tube 70, and the second locking device 50 is thus unlocked. In this manner, as shown in FIG. 6, the locking block 24 of the first locking means 20 is engaged with the middle hole 46 of the second sliding tube 40, and makes the handle grips go up a small distance above the recess on the top of luggage and locked therein so as to provide a carry-on handle to the user when lifting luggage.

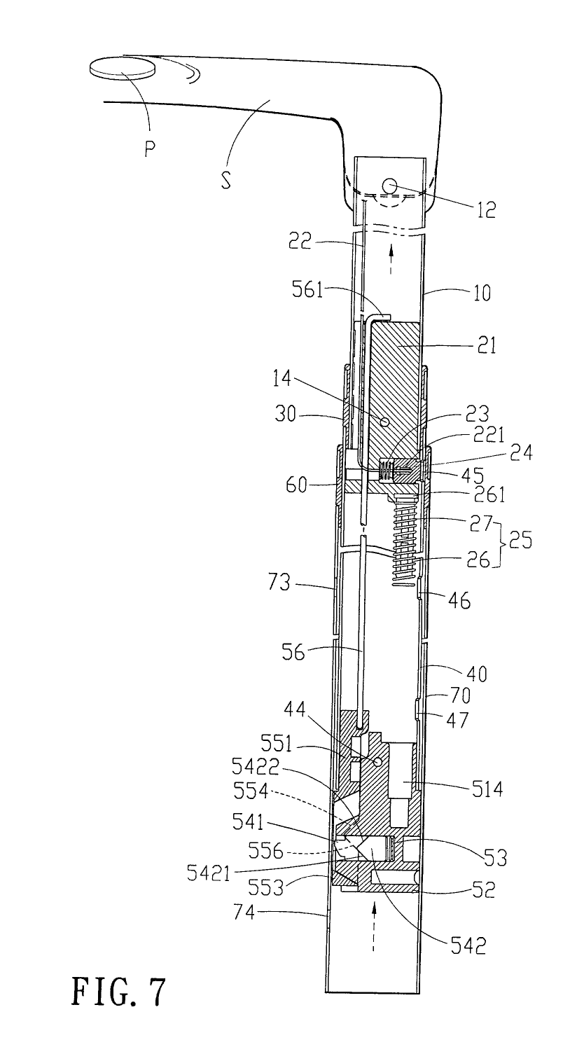

Referring to FIG. 7, after the generally cubic shaped locking block 54 is unlocked, the second locking device 50 is activated. If the user then chooses to raise the handle grip further, the general ascent of the second connecting means 56 will drag the second locking device 50 upward, which in turn will cause the second sliding tube 40 to be extended. In this manner, the luggage handle's supporting barrels are stretched one by one to fulfill the locking device's general action of protraction. FIG. 8 is an exploded view of a retractable handle on the left-hand side of the luggage according to the present invention.

The following narrative provides a more detailed understanding of the mutual relations among the many mechanical components, which constitute the luggage handle's locking mechanism. The jumping means 25 is provided in the first locking device 20 and is installed at the bottom of the first sliding tube 10; the spring receptacle 514 is fixedly provided within the second locking device 50 and is installed at the bottom of the second sliding tube 40, and the second connecting means 56 is clung to the vertically deployed sliding block 55 as a trigger member in the second locking device 50. When neither the first and the second sliding tubes is protracted, the jumping means 25 sits on the spring receptacle 514 and together they form a working mechanism whose major task is to activate the first locking device 20 and raise the first sliding tube 10; the performance gravity at this stage is on the first locking device 20. After the first sliding tube 10 is protracted, the jumping means 25 no longer sits on the spring receptacle 514, and the relative loci of the second connecting means 56 become a crucial element for controlling the protraction of the second sliding tube 40; the performance gravity at this stage is now on the second locking device 50. However, the provision of the second locking device 50 is important throughout. Even though originally, when no barrel was protracted, and the first locking device 20 played a major role in accomplishing the task of protracting the first sliding tube 10, the existence of the spring receptacle 514 on the second locking device 50 was still an indispensable element for the proper function of the jumping means 25, which is located on the first locking device 20.

Perceivably, with this design, the desirable relative loci of the jumping means 25, the spring receptacle 514, and the second connecting means 56 enable the user to control the motion of the first sliding tube 10, the second sliding tube 40, and the supporting tube 70, regardless of their relative physical lengths. For this reason, the locking device does not need to account for the spring receptacle's special anchoring position and the composing barrels' specific relative lengths. In other words, with such a design, any combination of barrel lengths can assure a smooth enforcement of the luggage handle's jumping action and protraction operation. This favorable point enables the manufacturer to manufacture a first sliding tube 10 and a second sliding tube 40 with suitable lengths based entirely on the retraction requirements placed on them; therefore, it is possible for the manufacturer to produce a great variety of luggage handles with different retraction lengths. In addition, the promoted features of the luggage handles, such as better jumping, smooth retraction, and a quick extension of the locking device, can also be fulfilled.

While the invention herewith disclosed has been described by means of specific embodiments, numerous modifications and variations can be made thereto by those skilled in the art without departing from the scope and spirit of the invention set forth in the claims.

What is claimed is:

1. A handle assembly of wheeled luggage provided on a back portion of the luggage having:
a handle with a handle grip (S) having opposing ends and a push button (P) located between the ends and operable at a first position and a second position;
a pair of first sliding tubes (10) connected to the respective ends of the handle grip;
a pair of second sliding tubes (40), slidably engaged with the first sliding tubes for allowing the respective first sliding tubes to slide therein; and
a pair of supporting tubes (70), slidably engaged with the second sliding tubes for allowing the respective second sliding tubes to slide therein, when the handle is pulled upward to a used position and pushed downward to a stored position, said assembly comprising:
a pair of first locking devices (20) operatively connected to the push button (P);
a pair of second locking devices (50), engaged with the respective second sliding tubes (40), for securing the first sliding tubes (10) to the respective second sliding tubes (40) in a locked position when the handle is operated in the stored position, wherein the second locking devices (50) are operatively connected to the respective first locking devices (20) for allowing the first locking devices (20) to release the respective second locking devices (50) from the locked position when the push button is operated in the first position; and
a pair of biasing mechanisms (25), operatively engaged with the first locking devices (20), for applying an urging force against the respective second sliding tubes (40) when the push button (P) is operated in the first position, for pushing the first locking devices (20) toward the handle for releasing the second locking devices (50) from the locked position.

2. The handle assembly of claim 1, wherein each of the supporting tubes (70) has a hole (74) and each of the second locking devices (50) has a locking pin (541) for engaging with the hole (74) in the respective supporting tubes (70) when the second locking devices (50) are operated in the locked position, and disengaged from the hole (74) when the second locking devices (50) are released from the locked position.

3. The handle assembly of claim 2, wherein each the second locking devices (50) further comprises a sliding block (55) located adjacent to and operatively engaged with the respective locking pin (541), and wherein the sliding block (55) is connected to the respective first sliding tube (10) by a connecting means (56) for pulling the sliding block (55) away from the respective locking pin (541), thereby causing the locking pin (541) to disengaged from the hole (74) when the handle is pulled upward to the used position.

4. The handle assembly of claim 3, wherein each of the first locking devices (20) has a guiding pin (240) which can be engaged with an aperture (47) on the respective second sliding tube (40) in a securing position to prevent the handle from being pulled upward when the push button (P) is operated in the second position, and wherein the guiding pin (240) is disengaged from the aperture (47) when the push button (P) is operated in the first position.

5. The handle assembly of claim 4, wherein each of the first locking devices is operatively connected to the push button by a further connecting means (22) for disengaging the guiding pins (240) from the respective aperture (47) when the push button is operated in the first position.

6. The handle assembly of claim 5, wherein each of the second sliding tubes (40) further having a further aperture (45) for engaging with the respective guiding pin (240) to secure the first sliding tube (10) to the respective second sliding tube (40) when the handle in operated in the used position.

7. The handle assembly of claim 4, wherein each of the supporting tubes (70) further having a further hole (73) for engaging with the respective locking pin (541) to secure the second sliding tube (40) to the respective supporting tube (70) when the handle is operated in the used position.

8. The handle assembly of claim 1, wherein each biasing mechanism (25) has a spring (27) for providing the urging force.

9 The handle assembly of claim 5, wherein each of the second sliding tubes (40) further has a middle aperture (46) for engaging with the respective guiding pin (240) to secure the first sliding tube (10) to the respective second sliding tube (40), wherein the handle is pulled a small distance above the top of the luggage when the handle is operated in a carry-on position.
